(19) United States
(12) Patent Application Publication
(10) Pub. No.: US 2016/0125323 A1
(43) Pub. Date: May 5, 2016

(54) ELECTRONIC TICKET SYSTEM AND PROGRAM

(71) Applicant: LEONIS & CO., INC., Tokyo (JP)

(72) Inventors: Masutomo UENISHI, Tokyo (JP); Keiji ITO, Tokyo (JP); Aki OHARA, Tokyo (JP)

(21) Appl. No.: 14/889,886

(22) PCT Filed: May 21, 2014
(86) PCT No.: PCT/JP2014/063432

§ 371 Date: Nov. 9, 2015

(30) Foreign Application Priority Data
May 22, 2013 (JP) 2013-120218
May 12, 2014 (JP) 2014-098242

(51) Int. Cl. G06Q 10/02; G06F 3/0488; G06K 19/06

(52) U.S. Cl. CPC G06Q 10/02; G06K 19/06037; G06F 3/0488

(57) ABSTRACT

Provided is an electronic ticket system enabling easy confirmation and tracking of use statuses. Provided is a service information providing system including: a user terminal for displaying an electronic ticket on the displaying means, having displaying means for displaying information, and having a touch panel, provided overlaying the displaying means, having inputting means wherein respective contact positions of simultaneous contacting of a plurality of positions are detectable; and a stamp having a plurality of pressing portions for which simultaneous contacts to the inputting means are detectable; wherein: when, in the user terminal, there are simultaneous contacts by pressing portions of the stamp, in a state wherein an electronic ticket is displayed on the displaying means, a plurality of contact positions are detected by the inputting means, and when the detected contact positions satisfy predetermined conditions, an image is drawn indicating that the electronic ticket has been used.

### TECHNICAL FIELD

The present invention relates to an electronic ticket system for issuing an electronic ticket to a mobile terminal, such as a smart phone, and for identifying that the electronic ticket has been used.

### BACKGROUND ART

Conventionally, coupons and loyalty point services have been carried out in a variety of forms as sales promotion activities targeting product sales and attracting customers. One example is that of coupons, distributed on paper or through the Internet (see, for example, Patent Literature 1). In this format, a customer in a retail store, when making a purchase, presents, to a staff member, a coupon issued by the retail store, to receive preferential service in accordance with the terms of the coupon. It is noted that an example of forms of loyalty point includes proof-of-purchase stickers (seals), with sticker books for affixing the stickers. Because services in this form do not require large investments to implement, they have the benefit of being carried out easily even by retail stores independently.

Moreover, a mechanism is being achieved wherein entry tickets for various types of events, such as concerts, movies, and sporting events, tickets for using traffic facilities, vouchers for products purchased in advance, and the like are also issued through the Internet or the like to mobile terminals of users in the form of electronic tickets, to enable enjoyment of services, such as entry into the event venue or use of the traffic facility, through presenting the electronic ticket. In the description below, electronically issued coupons, stamp cards, event tickets, product vouchers, and other coupons and tickets issued electronically, through the Internet or the like, shall be termed, in general, “electronic tickets”.

### CITATION LIST

### Patent Literature

Patent Literature 1 Japanese Unexamined Patent Application Publication 2007-157102

### SUMMARY OF INVENTION

### Technical Problem

However, in the form set forth in Patent Literature 1, discerning when and where, what coupon has been used by what customer, and discerning data for per-customer sales, points issued in accordance therewith and the like, is not easy. Because of this, it has actually been difficult, on the retail store side, to use coupons and points effectively and efficiently as means for promoting sales. Confirming and tracking the state of use of event tickets has similarly been difficult.

### Solution to Problem

Given this, the object of the present invention is to provide an electronic ticket system able to solve the problems described above. This object is achieved through a combination of the distinctive features described in the independent claims in claims. Moreover, the dependent claims specify more advantageous, specific examples of the present invention.

In order to achieve the object set forth above, an electronic ticket system according to a first aspect of the present invention comprises: a user terminal for displaying an electronic ticket on displaying means, having a touch panel having: the displaying means for displaying information; and inputting means provided overlaying the displaying means, the inputting means being capable of detecting respective contact positions of simultaneous contacting of a plurality of positions; and a stamp having a plurality of pressing portions for which simultaneous contacts to the inputting means are detectable, wherein when, in the user terminal, there are simultaneous contacts by pressing portions of the stamp in a state wherein an electronic ticket is displayed on the displaying means, a plurality of contact positions are detected by the inputting means, and if the detected contact positions satisfy predetermined conditions, an image is drawn indicating that the electronic ticket has been used.

The electronic ticket system may further comprise a server device able to communicate with a user terminal. Additionally, the user terminal may be configured so as to provide notification, to the server device, that the electronic ticket has been used, when the detected contact positions satisfy the predetermined conditions.

If the electronic ticket system further comprises a server device able to communicate with a user terminal, then the server device may store information pertaining to the layout of the plurality of pressing portions of the stamp, in relation to the electronic ticket corresponding to the stamp; and when, in a state wherein the electronic ticket is displayed on the displaying means, if all of the pressing portions of a stamp are detected, by the inputting means, as having made contact simultaneously, the user terminal may query a stamp database of the server device as to whether or not the detected contact positions correspond to the displayed electronic ticket, and if there is a response to the effect that they correspond, an image indicating that the electronic ticket has been used may be drawn on the displaying means. In this case, the server device may record that the electronic ticket has been used by the user of the user terminal, at the time of the response to the effect that they correspond, to the query from the user terminal, indicating that there is a correspondence. Moreover, the server device may further comprise an information providing portion for providing an electronic ticket addressed to the user.

In a state wherein the displaying means displays an indication of a request for an electronic ticket, when there is contact simultaneously by all of the pressing portions of the stamp, the plurality of contact positions may be detected by the inputting means, and the user terminal may request the server device to provide an electronic ticket corresponding to the detected contact positions, and, in response to the request from the user terminal, the server device may provide an electronic ticket, corresponding to the contact positions, to the user terminal that is the source of the request.

In order to achieve the object set forth above, a program according to a second aspect of the present invention is a program that runs on a user terminal that comprises: a touch panel having: displaying means for displaying information; and inputting means provided overlaying the displaying means, the inputting means being capable of detecting respective contact positions of simultaneous contacting of a plurality of positions; and an information storing portion for storing for displaying an electronic ticket on the displaying means of the touch panel; the program causing execution, on the user terminal, of: a step for causing the electronic ticket to be displayed on the displaying means; a step for detecting contact positions of the inputting means contacting a plurality of positions simultaneously in a state wherein the electronic ticket is displayed on the displaying means; and a step wherein, when the detected contact positions correspond to the electronic ticket that is displayed, an image is drawn, on the displaying means, indicating that the electronic ticket has been used.

Note that the summary of the invention set forth above does not list comprehensively all of the characteristics required in the present invention, and sub combinations within the set of features may also constitute the invention.

### BRIEF DESCRIPTIONS OF DRAWINGS

FIG. 1 is a diagram illustrating a configuration of a coupon issuing system 10.

FIG. 2 is a diagram illustrating a configuration of a mobile terminal 20.

FIG. 3 is a diagram illustrating a structure of a stamp 30.

FIG. 4 is a block diagram illustrating a configuration of a server 40.

FIG. 5 is a diagram illustrating one example of data that is stored in a coupon information database.

FIG. 6 is a flowchart illustrating a procedure for issuing a coupon issuing system 10.

FIG. 7 is a diagram illustrating one example of a screen displayed on a mobile terminal 20 prior to issuing of a coupon.

FIG. 8 is a diagram illustrating one example of a coupon that has not been used, displayed on a mobile terminal 20.

FIG. 9 is a flowchart illustrating a procedure for using a coupon issuing system 10.

FIG. 10 is a diagram illustrating an example display of a coupon that has been used.

FIG. 11 is a flowchart illustrating a procedure for using a stamp rally system.

FIG. 12 is a diagram illustrating one example of a screen displayed on a mobile terminal 20 prior to the application of a stamp.

FIG. 13 is a diagram illustrating one example of a screen displayed on the mobile terminal 20 after the application of a stamp.

FIG. 14 is a diagram illustrating another example of a screen displayed on a mobile terminal 20 prior to the application of a stamp.

FIG. 15 is a block diagram illustrating a configuration of a server 40 in a third embodiment.

### DESCRIPTION OF EMBODIMENTS

### First Embodiment

### Example of Application to Coupon Issuing System

A coupon issuing system 10, which is a first embodiment of an electronic ticket system according to the present invention will be explained below, referencing the drawings.

### [Configuration of Coupon Issuing System 10]

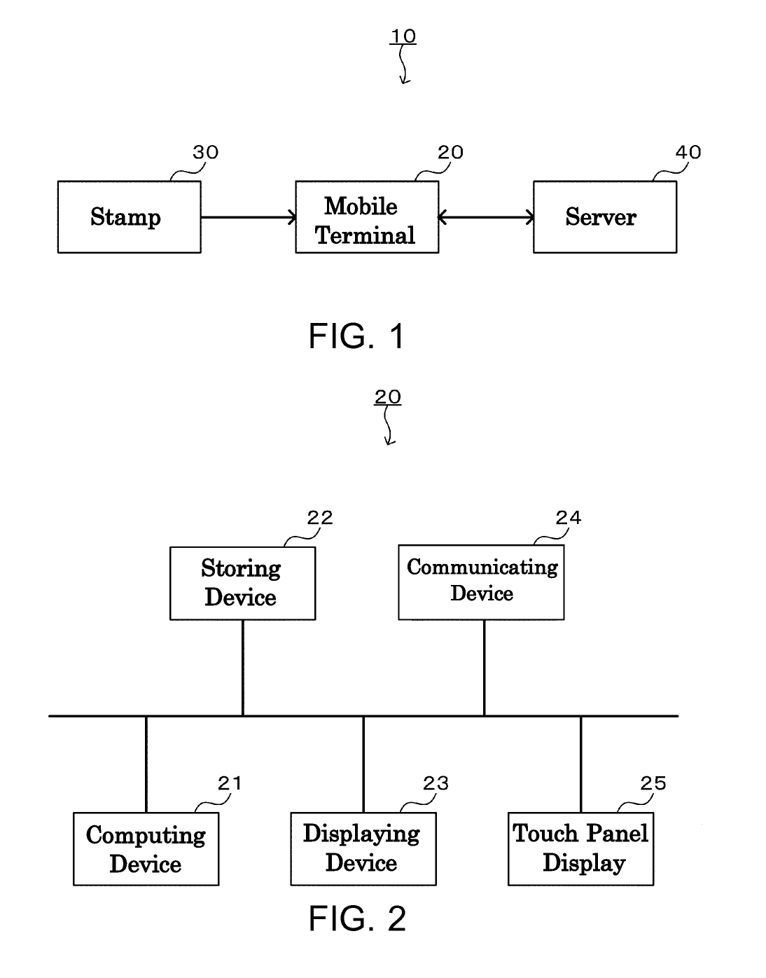

FIG. 1 is a diagram illustrating a configuration of the coupon issuing system 10. The coupon issuing system 10 comprises a mobile terminal 20, a stamp 30, and a server 40. The mobile terminal 20 and the server 40 each run applications so as to function as constituent elements of the coupon issuing system 10 according to the present invention. The mobile terminal 20 and the server 40 are configured so as to enable communication through a network, such as the Internet. The stamp 30 is disposed in a store wherein a coupon issued by the coupon issuing system 10 can be used, and is used in order to issue coupons and/or cancel coupons.

FIG. 2 is a diagram illustrating a configuration of the mobile terminal 20. The mobile terminal 20 comprises: a computing device 21, such as a CPU, for carrying out computing processes of an application; a storing device 22, such as a RAM or hard disk, for storing information; a displaying device 23, such as a display (screen); a communicating device 24, for exchanging, through a network such as the Internet or a LAN, the results of processing by the computing device 21 or information stored in the storing device 22; and a multi-touch-compatible touch panel display 25 for identifying layout information of the stamp 30. In each function (each means) achieved on the computer, processes are executed through the commands (command sets) for executing the procedure being read into the computing device 21. In each function, if information stored in the storing device 22 is to be used in that process, then the applicable information is read out from the storing device 22 and the information that has been read out is used, as appropriate, in processes by the computing device 21.

The multi-touch-compatible touch panel display is a touch panel able to detect contacts at a plurality of points with fingers, pen points, or the like. The stamp 30 according to the present invention is caused to contact the mobile terminal 20 in which the multi-touch-compatible touch panel display is installed. Note that the displaying device 23 may also function as the multi-touch-compatible touch panel display 25. Note that while there is are variety of methods for sensing contacts in touch panels, an example of a case wherein the touch panel is of the electrostatic capacitance type will be explained in the present embodiment.

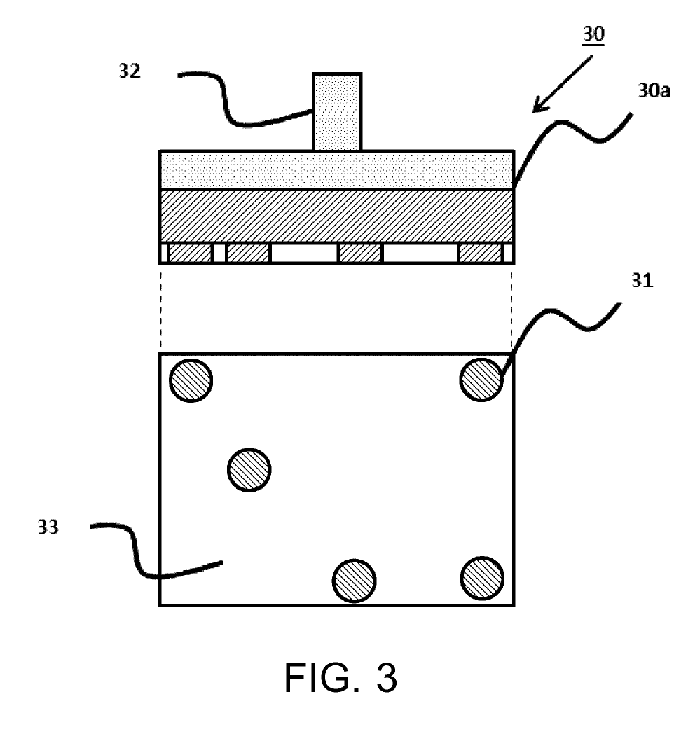

FIG. 3 is a diagram illustrating a structure for the stamp 30. The stamp 30 comprises: a main unit portion 30a; electrodes 31; a handle 32; and a stamping surface 33. The main unit portion 30a of the stamp 30 is provided with a handle 32 on an upper portion thereof, where the bottom face, on the side that is opposite of the side wherein the handle 32 is provided, is the stamping surface 33. The stamping surface 33 and the cross-section of the main unit portion 30a that is parallel to the stamping surface 33, are formed into the shape of a square stamp.

The stamp 30 is provided with five electrodes 31, which are pressing portions that cause the layout information of the stamp 30 to be detected through being contacted simultaneously with the multi-touch-compatible touch panel display 25 of the mobile terminal 20. The five electrodes 31 are provided fixedly on the stamping surface 33, to maintain predetermined positional relationships therebetween, so that when they simultaneously contact the mobile terminal 20, the positional relationships can be identified. Of the five electrodes 31, three are disposed in the vicinities of three corners of the square that is the stamping surface 33. Arranging the electrodes 31 in this way enables identification of the top, bottom, left, and right of the stamp 30, regardless of the orientation with which the stamping surface 33 of the stamp 30 contacts the touch panel display 25. The electrodes 31 are structures that protrude to the stamping surface 33, formed as circles from conductive materials. Preferably the electrodes 31 are formed from conductive materials. Moreover, preferably the electrodes 31 and the main unit portion 30a are of semitransparent materials. The electrodes 31 and the main unit portion 30a being formed from conductive and semitransparent materials makes it possible, through drawing, on the stamping surface 33, the image that will be displayed when the stamp 30 is pressed against the touch panel display 25, to produce the appearance that the image that is drawn being stamped onto the mobile terminal 20 when the stamp 30 is contacted to the mobile terminal. Preferably, the parts other than the electrodes are filled with an insulative (non-conductive) material such as resin, causing the stamping surface to be essentially flat. Doing so makes it possible to prevent a feeling of instability at the time of stamping caused by the corner wherein there is no electrode disposed, enabling reliable contact of all of the electrodes with the touch panel display simultaneously. Preferably the color of the electrodes and the color of the material that fills the non-electrode parts should be the same color (for example, clear). Doing so makes it difficult to visually recognize the positions of the electrodes, thereby enabling prevention of unauthorized copying of the stamp.

The handle 32 is the position that is grasped when stamping with the stamp 30. The handle 32 is made from a conductive material. The stamping surface 33 is the location for disposing of the electrodes 31, and is formed from a conductive material. Note that the configuration of the stamp 30, described above, is a suitable material and configuration for the stamp 30 that is to be used on a touch panel display using a touch panel of an electrostatic capacitance type. If the mobile terminal 20 employs a touch panel display of another type, then the stamp 30 should employ materials and structures of characteristics that are suitable for the type of touch panel. If conductivity is not required, then a plurality of non-conductive pressing portions that are able to contact the touch panel display simultaneously may be provided in the stamping surface 33 of the stamp 30.

As described above, in the stamp 30, the electrodes 31 are disposed on the stamping surface 33 so as to apply, to the touch panel display 25, effects same as those of touching a plurality of points with tips of fingers, pen points, or the like. Different layout information for the electrodes 31 is established for each individual coupon. Because of this, it is possible to identify the type of coupon from the layout information of the electrodes 31. Moreover, by displaying a coupon on the mobile terminal 20 and contacting the electrodes 31 to the screen whereon the coupon is displayed, it is possible to identify the coupon as having been used. While it is possible to use fingertips to make the contact similar to that of touching the touch panel display 25 with the electrodes 31 of the stamp 30, in consideration of hygiene and the stress on the user with the screen of the mobile terminal 20 contacted directly by others, when making direct contact with the mobile terminal 20, the use of fingertips to identify the layout information would not be suitable. Moreover, while it is also possible to use the pen points to make the contact similar to contact using the stamp 30, identifying layout information using pen points would not be suitable. It is significant that the procedures from issuing the coupon through confirming use of the coupon are carried out using the stamp 30.

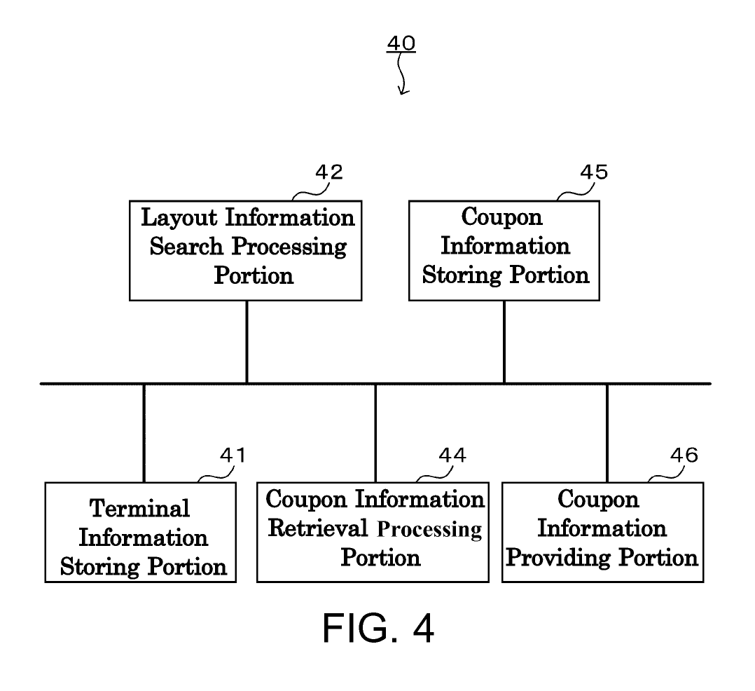

FIG. 4 is a functional block diagram illustrating a configuration of the server 40. The server 40 has a terminal information storing portion 41, a layout information retrieval processing portion 42, a coupon information retrieval processing portion 44, a coupon information storing portion 45, and a coupon information providing portion 46. These functional blocks are achieved through commands (command sets) for carrying out these processes being read in and executed on a computing device such as a CPU, using the computing device, a storing device, such as a RAM or a hard disk, for storing information, and a communicating device, such as a network interface.

The terminal information storing portion 41 stores information for the mobile terminal 20 of the user. The information for the mobile terminal 20 of the user includes information identifying the mobile terminal 20, the date and time at which a communication was received from the mobile terminal 20, information regarding the location of the mobile terminal 20, and the like.

The layout information retrieval processing portion 42 receives layout information of the electrodes 31, transmitted from the mobile terminal 20 of the user, and sends, to the coupon information retrieval processing portion 44, the layout information that has been received from the electrodes 31. Moreover, the layout information retrieval processing portion 42 retrieves and extracts the requested layout information from the layout information that is stored in the coupon information storing portion 45.

The coupon information retrieval processing portion 44 receives coupon acquisition requests transmitted from the mobile terminal 20 of the user or layout information transmitted from the layout information retrieval processing portion 42, to retrieve and extract the requested coupon information from the coupon information that is stored in the coupon information storing portion 45. The layout information for the electrodes 31 that are arranged in the stamp 30 that contacted the mobile terminal 20 of the user, may be acquired from the mobile terminal 20 of the user and used as the coupon information retrieval conditions. Given this, the coupon information corresponding to the layout information that has been acquired is retrieved from the coupon information storing portion 45.

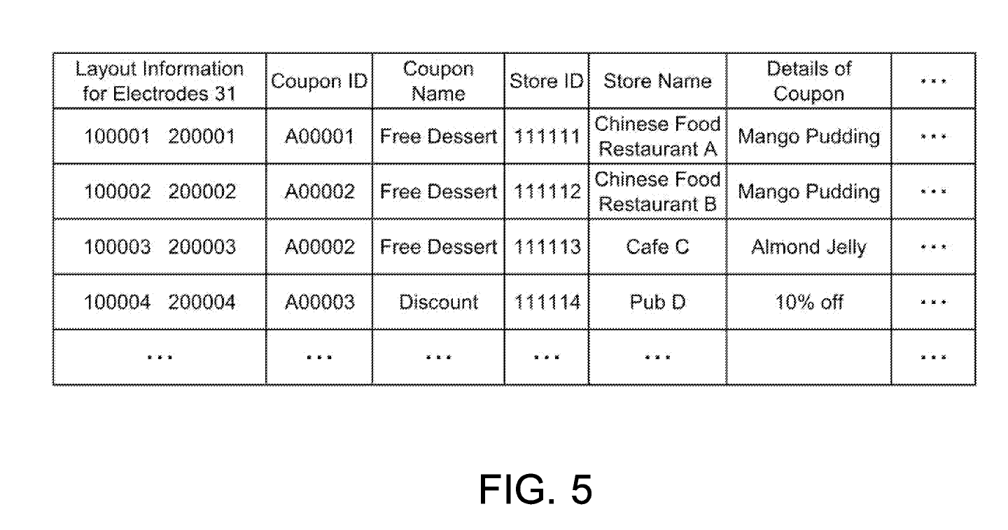

The coupon information storing portion 45 stores information regarding the coupon (termed simply “coupon information”). FIG. 5 shows schematically an example of the coupon information storing portion 45. The information pertaining to the coupon may include, for example, coupon identifying information for identifying the coupon (layout information for the electrodes 31 that are arranged in the stamp 30, an ID or coupon name for identifying the coupon, and the like), identifying information for the store wherein the coupon can be used (store name or an ID, or the like, for identifying the store), the details of the service that can be accessed with the coupon (for example, a 20% discount, one product for free, one free drink, one free admittance, or the like), information relating to the store wherein the coupon can be used (address, telephone number, or the like), information for an event associated with the coupon, location information for the location wherein the event is to be held, map information showing the route to the store from the location wherein the event is held, an image on a ticket face for a coupon that is not used, an image on a ticket face that has been used, the time interval over which the coupon is delivered, the period of the validity of the coupon, an upper limit for the number of uses of the coupon (the number of users who can use the coupon, where further use of the coupon is prohibited after the total number of users of the coupon has reached this number), the total number of users of the coupon, and the like.

The coupon information providing portion 46 receives a coupon information acquisition request from the mobile terminal 20 of the user, and, in response to the acquisition request, sends, to the mobile terminal 20 of the user, coupon information that has been retrieved and extracted by the coupon information retrieval processing portion 44.

[Registration of Coupon Information into Coupon Information Storing Portion 45]

The server 40 provides, to the administrator, such as the issuer of the coupon, a registration screen for registering coupon information into the coupon information storing portion 45. The administrator accesses the registration screen through the Internet, for example, to register the above described coupon information into the coupon information storing portion 45.

The layout information for the electrodes 31 that are arranged in the stamp 30 is registered by the administrator into the coupon information storing portion 45 through the mobile terminal 20. The server 40 provides the administrator with a stamp registering screen for registering the layout information for the electrodes 31 that are arranged in the stamp 30. The administrator accesses the stamp registration screen by using the mobile terminal 20 through, for example, the Internet. The stamp registering screen displays, for example, a stamping region for applying the stamp that is to be registered, an input field for coupon identifying information for the coupon that is to be associated with the stamp, a register button for initiating the registration, and so forth. After inputting the coupon identifying information into the input field and touching the register button to enable registration of the stamp, the administrator applies the stamp to the stamping region. The mobile terminal 20 identifies, through the touch panel display 25, the layout of the electrodes 31 in the stamp 30 that has been applied, defines the association between the coupon identifying information and the layout information, and transmits it to the server 40. The server 40 registers, into the coupon information storing portion 45, the layout information in association with the coupon identifying information that has been received from the mobile terminal 20 of the administrator.

Note that while in the example above the coupon information and the stamp layout information are managed together in the coupon information storing portion 45, the coupon information and the stamp layout information may instead be managed separately, and information for identifying the stamp that corresponds to the coupon may be associated with the coupon identifying information in the coupon information storing portion 45. Managing the coupon information and the layout information for the stamp separately makes it easy to assign, to multiple coupons, stamps that have been registered previously, or to reuse a stamp as a stamp for another coupon after a coupon has expired.

[Operations when Issuing Coupon]

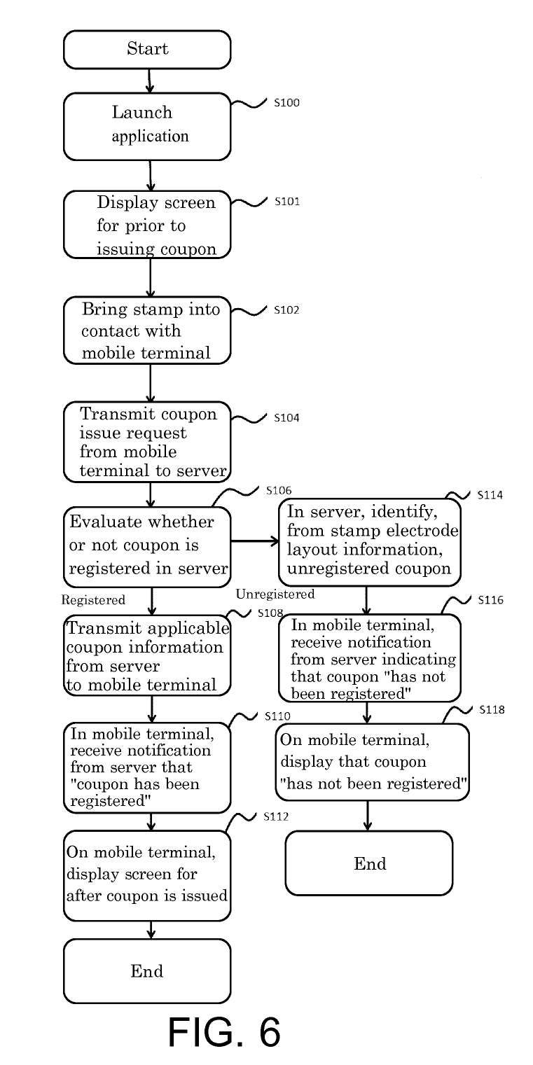

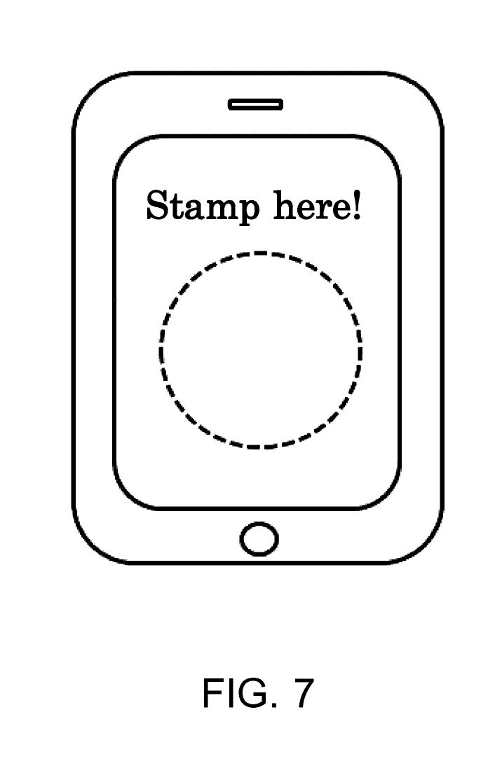

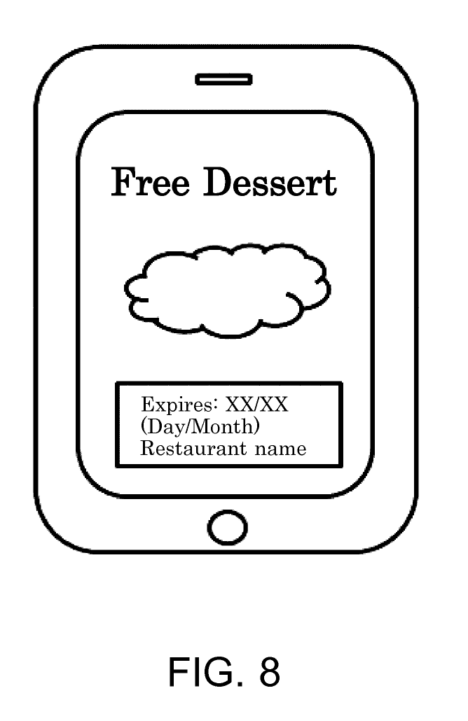

Then, FIG. 6 will be referenced to explain the operations when issuing a coupon in the coupon issuing system 10. FIG. 6 is a flowchart illustrating the procedure for issuing a coupon through the coupon issuing system 10. First the user launches an application on the mobile terminal 20 (step S100). Following this, the application is operated so as to display, on the mobile terminal 20, a screen for prior to the coupon being issued, as illustrated in FIG. 7 (step S101), after which the application is operated so as to send, to the server, a coupon issue request. Specifically, the request is sent through bringing the stamp into contact with the mobile terminal 20 (step S102). Given this, a coupon issue request is sent, in association with the layout information for the electrodes 31, to the server 40 from the mobile terminal 20 (step S104). At the server 40, the request is received by the coupon information providing portion 46, and the coupon information corresponding to the layout information is retrieved, and an evaluation is performed as to whether or not the requested coupon information has been registered in the server 40, by the layout information retrieval processing portion 42 (step S106). If the coupon information has been registered, then the server 40 transmits the coupon information to the mobile terminal 20 through the coupon information providing portion 46 (step S108), and the mobile terminal 20 receives the information (step S110). When the mobile terminal 20 receives the coupon information, a screen for after the coupon has been issued, as illustrated in FIG. 8, is displayed on the touch panel display 25 of the mobile terminal 20 (step S112).

On the other hand, if the coupon information is not registered in the server 40, then the coupon cannot be identified (step S114), and thus notification indicating that the coupon cannot be used is sent from the server 40 to the mobile terminal 20, and is received by the mobile terminal 20 (step S116). The mobile terminal 20 that has received this notification displays that the coupon has not been registered (step S118), and terminates processing. If a coupon that has not been registered is requested, the user is unable to use that coupon. Consequently, this makes it possible to prevent incorrect use of a coupon, such as use of the coupon that is outside of the valid period of use. Moreover, this can prevent cheating, such as counterfeiting of coupons.

When, in this way, the use of an electronic stamp according to the present invention to issue a coupon enables the issuing of a coupon that gives the user a feeling of special treatment. For example, by providing notification in advance that coupons will be distributed only to those who visit the store, and providing the electronic stamp according to the present invention at the store, it is possible to issue coupons limited to individuals who actually visit the store. Doing so can assertively provide motivation for the customers to physically visit the store. Moreover, it is possible to issue coupons limited to users that have visited the store. This makes it possible to provide the user with a feeling of premium service, having a coupon that cannot be obtained without visiting the store.

As the conditions for retrieving the coupon information, the layout information for the electrodes 31 that are arranged in the stamp 30 is acquired by the mobile terminal 20 of the user when the stamp 30 is brought into contact with the mobile terminal 20 of the user, and the coupon information is retrieved from the coupon information storing portion 45 using that layout information. Moreover, the location information for the mobile terminal 20 may be included as a retrieval condition. Other conditions may also be set as retrieval conditions.

The coupon information retrieval processing portion 44 receives a request for a retrieval process for the coupon information from the mobile terminal 20 of the user, and the coupon information providing portion 46 sends, to the mobile terminal 20 of the user, the result of retrieving the applicable coupon information from the coupon information that is stored in the coupon information storing portion 45. There are the following three conditions under which the coupon information is retrieved.

The first is that, when a user visits a store, a staff member places the stamp 30 into contact with the mobile terminal 20 of the user, so that the mobile terminal 20 of the user acquires the layout information of the electrodes 31 that are arranged in the stamp 30, the layout information retrieval processing portion 42 receives a retrieval processing request for the layout information, and the applicable coupon information from the coupon information that is stored in the coupon information storing portion 45 is sent, as the result of the retrieval, by the coupon information providing portion 46 to the mobile terminal 20 of the user.

The second is that when a user visits a store, a coupon acquisition request is transmitted from the mobile terminal 20 of the user to the coupon information retrieval processing portion 44, and the applicable coupon information from the coupon information that is stored in the coupon information storing portion 45 is sent, as the result of the retrieval, to the mobile terminal 20 of the user from the coupon information providing portion 46.

The third is a push notification, from the server to the mobile terminal 20 of the user, of coupon information that is stored in the coupon information storing portion 45. As the conditions at the time of this notification, information regarding the mobile terminal 20 of the user, such as location information for the mobile terminal 20 that is transmitted to the terminal information storing portion 41, is compared to coupon information stored in the coupon information storing portion 45, and if there is matching information, a notification for the coupon information is sent from the server 40 to the mobile terminal 20 of the user. For example, if the location information for the mobile terminal 20, acquired by the mobile terminal 20, is the front of the Shibuya Train Station, for example, then, from among the coupon information stored in the coupon information storing portion 45, a coupon for which the location information for a store that has issued a coupon is the front of the Shibuya Train Station would be sent to the mobile terminal 20. If a type of coupon desired by the user (such as a type of cuisine (Japanese food, Chinese food, Italian food, French food, etc.), a type of eating/drinking establishment (a family restaurant, fast food, a rice bowl restaurant, a pub, Japanese food restaurant, a bar, a Chinese food restaurant, an Italian food restaurant, or the like), a price range for the eating/drinking establishment, or the like) is registered in advance, then these may be included in the retrieval conditions.

When a coupon is issued, first the layout information of the electrodes 31 of the stamp 30, which is the stamp information, and the detail of the coupon are registered in the server 40. Following this, the stamp information is acquired from the server 40 through a network, such as the Internet, by an application that is installed in the mobile terminal 20, and coupon information is received. The applicable coupon is then displayed in the application that is running on the mobile terminal 20.

Moreover, instead of a request through stamping with the stamp 30, as described above, means such as electronic mail may be used to deliver, from the server 40 to the registered user, the coupon itself or information for accessing a page for downloading the coupon (such as a URL). The registered users for the delivery may be limited based on attributes of the registered users, past coupon usage history, and the like. Moreover, coupons within the time interval over which the coupons are delivered may instead be downloaded automatically when the application is launched on the mobile terminal 20.

[Operations when Using Coupon]

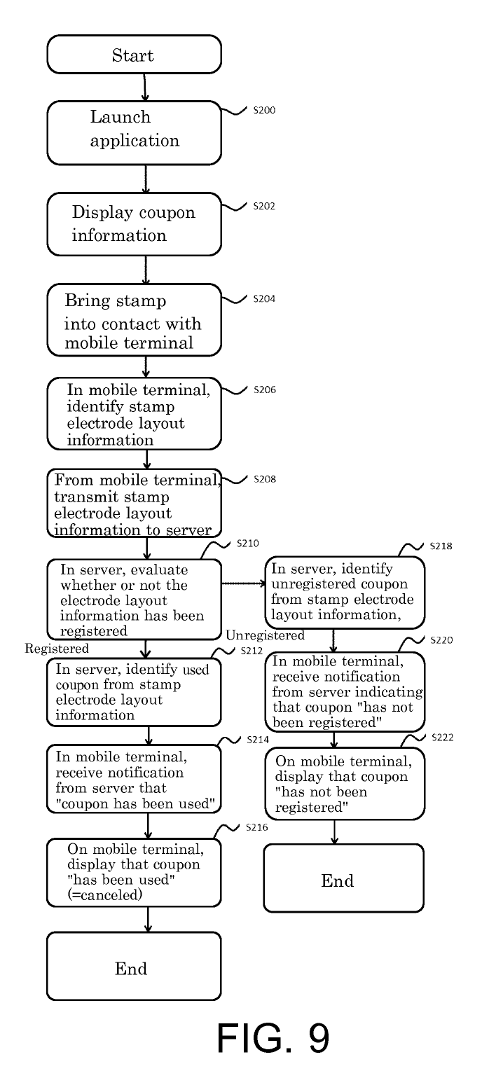

The operations when using the coupon issued through the coupon issuing system 10 will be explained next in reference to FIG. 9.

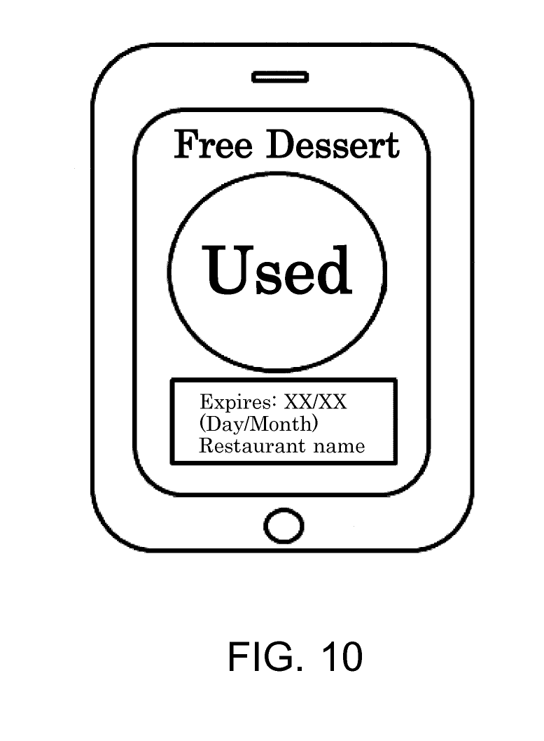

FIG. 9 is a flowchart illustrating the procedure for using a coupon issued through the coupon issuing system 10. First the user launches an application on the mobile terminal 20 (step S200). Following this, the application is operated to display, on the mobile terminal 20, a screen for an unused coupon, as illustrated in FIG. 8 (step S202). If an upper limit for the number of uses for the coupon has been established, then the number of uses remaining such as “5 tickets remaining” may be displayed on the screen. Given this, this screen is presented to a store wherein the coupon may be used. A staff member at the store brings the stamping surface of the stamp, which is arranged with layout information that is unique to the store, into contact with the screen of the mobile terminal 20. That is, in a state wherein the unused coupon is displayed on the screen, the stamp 30 according to the present invention is brought into contact with the touch panel display 25 (step S204). When this is done, the mobile terminal 20 identifies the layout information for the arrangement in the stamp 30, as illustrated in FIG. 3 (step S206). The identified layout information is transmitted through a network, such as the Internet, from the mobile terminal 20 to the server 40 (step S208). In the server 40, this layout information is received by the layout information retrieval processing portion 42, and the coupon information corresponding to the layout information is retrieved by the coupon information retrieval processing portion 44, to evaluate whether or not the coupon information has been registered in the coupon information storing portion 45 (step S210). If the layout information has been registered in the server 40, the applicable coupon is identified from the layout information that has been registered (step S212), and the server 40 sends, to the mobile terminal 20, a notification from the coupon information providing portion 46 that the user has used the coupon, which notification is received by the mobile terminal 20 (step S214). The mobile terminal 20 that has received this notification displays an image indicating that the coupon has been used, as illustrated in FIG. 10 (step S216), and processing is terminated. This enables the user to use the coupon that is displayed on the mobile terminal 20. In this way, when a registered coupon is used, the terminal information storing portion 41 discerns who used the coupon when, and in which store, and this information is accumulated in the terminal information storing portion. The store is able to use this information in carrying out marketing and sales promotion activities, in planning new coupons, and the like.

As a modified example for steps S208 through S216, the mobile terminal 20 may store in advance (for example, when the coupon is issued) coupon information in association with layout information corresponding to the coupon, so that when layout information is identified for the stamp 30 that has been applied, it may be compared to the layout information corresponding to the coupon that is displayed, and if the evaluation is that that the corresponding stamp 30 has been applied, an indication that the coupon has been used may be displayed, and notification indicating that the coupon has been used may be transmitted to the server.

In yet another example, coupon information (such as coupon identifying information) for a coupon that is displayed (that is to be used) is transmitted, by the mobile terminal 20 to the server 40, along with layout information of the stamp that has been applied, and, in the server 40, layout information corresponding to the coupon that is to be used is retrieved and compared with layout information for the stamp 30 that has been applied, and if the evaluation is that the corresponding stamp 30 has been applied, then a notification is sent, to the mobile terminal 20, so as to produce a display indicating that the coupon has been used.

On the other hand, if the layout information has not been registered in the server 40, then the coupon cannot be identified (step S218); notification is sent from the server 40 to the mobile terminal 20 indicating that the coupon cannot be used, and this notification is received by the mobile terminal 20 (step S220). The mobile terminal 20 that has received this notification produces a display indicating that the coupon is not registered (step S222), and processing is terminated. When an unregistered coupon is presented, the user is unable to use that coupon. Consequently, this makes it possible to prevent incorrect use of a coupon, such as use of the coupon that is outside of the valid period of use. Moreover, this can prevent cheating, such as counterfeiting of coupons.

### Second Embodiment

### Example of Application to Stamp Rally System

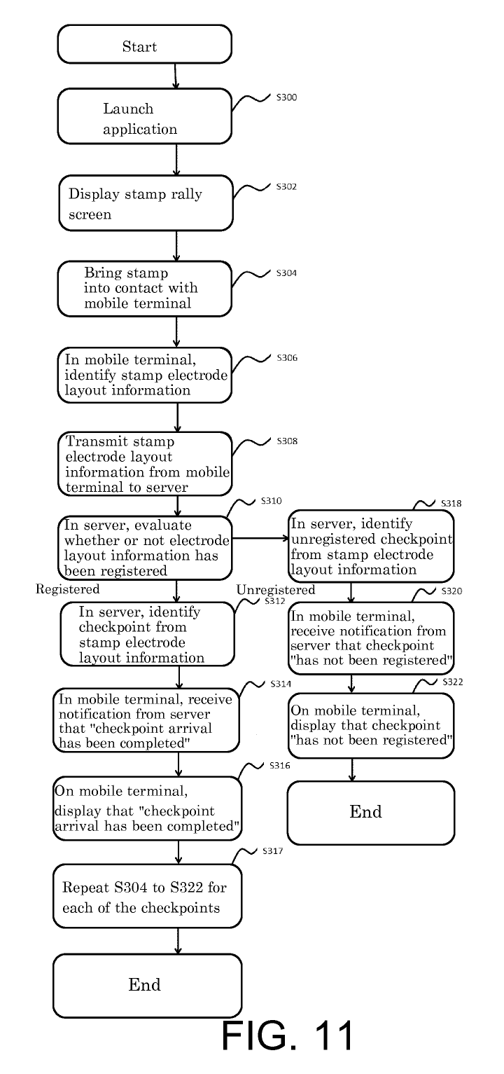

A stamp rally system that is a second embodiment according to the present invention will be explained next in reference to FIG. 11. The configuration of the stamp rally system is similar to that of the coupon issuing system 10 explained in the first embodiment in that it comprises the mobile terminal 20, the stamp 30, and the server 40, and while there are differences in operations and procedures for use, it is otherwise same as the coupon issuing system 10, and thus explanations will be omitted here for those parts that are in common.

The stamp rally system is provided with the mobile terminal 20, the stamp 30, and the server 40 similar to those in the coupon issuing system 10 of the first embodiment, described above. Explanations will be omitted here for items that are in common with those in the first embodiment, described above. The stamp 30 is provided for each of the multiple checkpoints in the stamp rally.

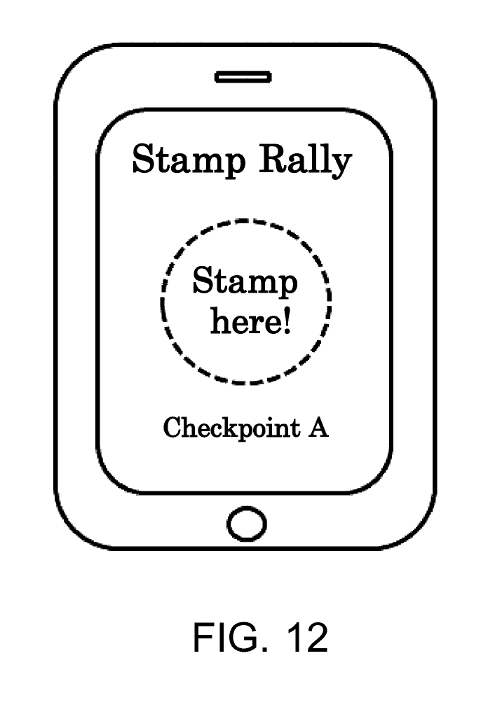

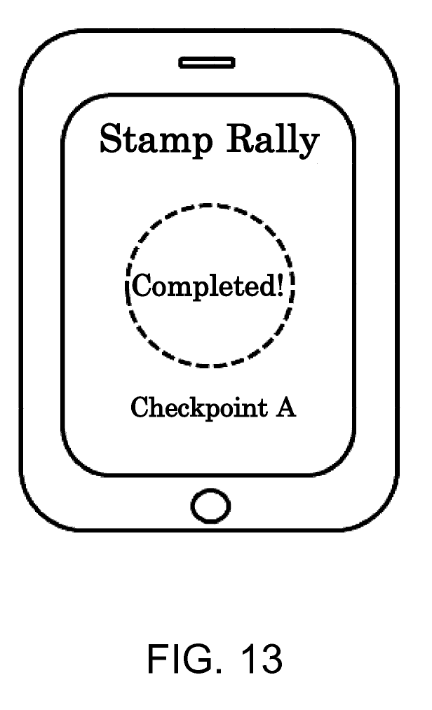

FIG. 11 is a flowchart illustrating the procedure for use when the stamp 30 is applied to a stamp rally system. Before starting this procedure, the participants in the stamp rally select, from a plurality of stamp rallies for which participation is possible, which are selectable in an application that is installed in the mobile terminal 20, a stamp rally in which to participate. When the stamp rally participant arrives at a checkpoint, the procedure that is illustrated in the flow chart is started. First an application is launched on the mobile terminal 20 (step S300). Following this, the application is operated to display, on the mobile terminal 20, a screen for the stamp rally, prior to stamping, as illustrated in FIG. 12 (step S302). The participant brings the stamping surface of the stamp 30, which is provided at the checkpoint and which is provided with layout information that is unique to that checkpoint, into contact with the screen of the mobile terminal. That is, in a state wherein the screen for the stamp rally, prior to stamping, is displayed, the stamp 30 is brought into contact with the touch panel display 25 (step S304). When this occurs, the layout information for the electrodes 31 that are arranged in the stamp 30, as illustrated in FIG. 3, is identified by the mobile terminal 20 (step S306). The identified layout information is transmitted through a network, such as the Internet, from the mobile terminal 20 to the server 40 (step S308). The server 40 receives the layout information, where coupon information corresponding to the layout information is retrieved by the coupon information retrieval processing portion 44, to evaluate whether or not the layout information has been registered in the server 40 (step S310). In this case, the server 40 may receive, together with the layout information, information identifying the stamp rally in which the user participates, information for identifying the participant, information for identifying the checkpoint, and the like. If the layout information has been registered in the server 40, then the applicable checkpoint is identified based on the registered layout information (step S312), and a notification is sent from the server 40 to the mobile terminal 20 that the user has arrived at the checkpoint, and the mobile terminal 20 receives this notification (step S314). Note that the configuration may be such that if the checkpoint that has been identified based on the layout information does not correspond to information for identifying the stamp rally or information identifying the checkpoint that has been received from the mobile terminal, the server 40 does not send notification of arrival at the checkpoint. Along with sending a notification to the mobile terminal 20, the server 40 records who has arrived at which checkpoint, and when. The mobile terminal 20, having received the notification, displays that the checkpoint has been reached, as illustrated in FIG. 13 (step S316), and terminates processing. This makes it possible for the user to record arrival at the checkpoint displayed on the mobile terminal 20. In this way, once arriving at the checkpoint, it is possible for the server 40 to identify who has arrived at which checkpoint when, and to accumulate this information.

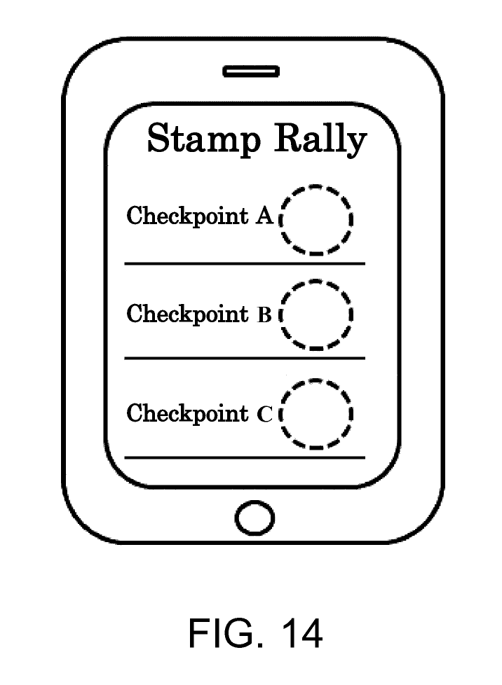

Note that while in the screen displayed on the mobile terminal 20, illustrated in FIG. 12 and FIG. 13 only a single checkpoint is displayed within a single screen, instead a plurality of checkpoints may be displayed within a single screen as in a modified example shown in FIG. 14. Displaying a plurality of checkpoints within a single screen enables presentation to the participant, in an intuitive, easily understood manner, the degree of progress toward the goal.

No ink is required when stamping with the stamp in the stamp rally system 11, and there is no need to worry about erroneous stamping or about the orientation of the stamp, making it easy to draw an image, on the mobile terminal 20, as if the correct stamp had been applied. Moreover, because there is no need for equipment such as power supply or communicating device, or the like, at the checkpoint itself, the checkpoint location can be set up easily. From the points described above, it is possible to set up large numbers of checkpoints easily in facilities, such as retail stores, wherein it is difficult to secure space for stamp rallies, causing customers to move about throughout the retail store.

On the other hand, if the layout information is not registered in the server 40, the checkpoint cannot be identified (step S318), so notification is sent from the server 40 to the mobile terminal 20 that the checkpoint cannot be identified, and this notification is received by the mobile terminal 20 (step S320). The mobile terminal 20 that has received this notification produces a display to the effect that the checkpoint is unregistered (step S322), and terminates processing. If a screen for an unregistered checkpoint is presented, then the participant cannot apply the stamp 30. Consequently if, for example, there is a mismatch between the actual arrival checkpoint and the screen that is displayed on the mobile terminal 20, the stamp 30 cannot be applied in error. Moreover, this is able to prevent cheating, such as pretending to have arrived at the checkpoint.

Participants who have applied the stamps 30 at all of the checkpoints, through the procedure illustrated in FIG. 11, in a stamp rally system, should be given coupons or prizes. For example, when the server 40 has confirmed that the stamps 30 have been applied at all of the checkpoints, then a coupon may be provided automatically to the mobile terminal 20 of the participant. Moreover, a prize or coupon may be received when a screen displaying that all of the stamps have been applied is presented to the promoter, or the like, of the stamp rally. When all of the stamps have been applied, ranking information indicating the rank order of arrival at all of the checkpoints, from among all participants, may be provided from the server 40 to the mobile terminal 20, and the coupon or prize may be awarded depending on that ranking information.

### Third Embodiment

### Example of Application to Ticket Processing System

A ticket processing system, which is a third embodiment according to the present invention, will be explained next. A ticket processing system is a system for issuing, and canceling after use, various types of tickets, such as entry tickets for various types of events such as concerts, movies, and sporting events, tickets for using traffic facilities, and the like. The configuration of the ticket processing system is similar to that of the coupon issuing system 10 explained in the first embodiment in that it comprises the mobile terminal 20, the stamp 30, and the server 40, and while there are differences in operations and procedures for use, it is otherwise same as the coupon issuing system 10, and thus explanations will be omitted here for those parts that are in common.

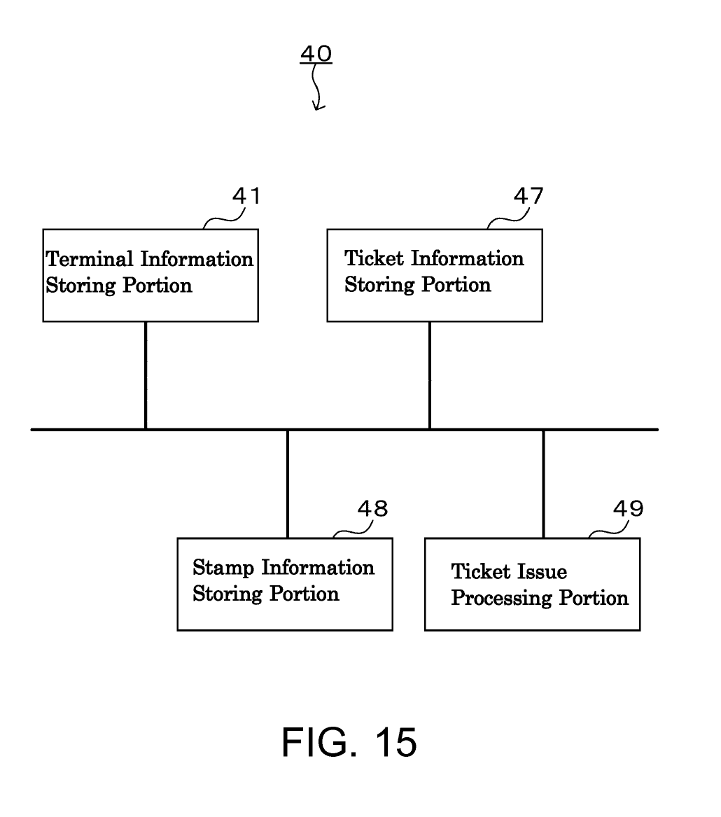

As illustrated in FIG. 15, the server 40 in the present embodiment has, for example, the terminal information storing portion 41, a ticket information storing portion 47, a stamp information storing portion 48, a ticket issue processing portion 49, and the like.

The ticket information storing portion 47 stores, in association with ticket identifying information, ticket names, ticket face information (images for before and after use, along with text information), ticket prices, periods of the validity of the ticket, seating positions at the events, stamp identifying information for the stamps 30 that are associated with the tickets, and the like. Each individual ticket may be associated with a plurality of stamp identifying information. Moreover, identical stamp identifying information may be assigned to a plurality of tickets.

The stamp information storing portion 48 stores stamp identifying information in association with layout information that indicates the arrangement of the electrodes that are arranged in the stamp 30. The method for registering the stamp 30 in the stamp information storing portion 48 may use the same technique as for registering the stamp 30 in the coupon information storing portion 45 in the coupon issuing system of the first embodiment.

The ticket issue processing portion 49 issues and transmits ticket information to the mobile terminal 20 of the user. The ticket issue processing portion 49 may issue tickets for free to a large number of users using the same technique as in the coupon issuing system of the first embodiment, or may instead issue tickets only to users who have completed a procedure for purchasing the ticket. In this case, the ticket issue processing portion 49 of the server 40 transmits, to the user that has completed the purchasing procedure, the ticket information (for example, the ticket name, the ticket face information (images and text information), the ticket price, the seating location at the event, and the like), or a URL for a site for downloading the ticket data.

The method by which to use the ticket processing system will be explained below, using, as an example, a case wherein an entry ticket for a music event is issued and the issued ticket is used at the event venue.

The user purchases a ticket following a predetermined procedure, and takes in ticket information for the purchased ticket in the application on the mobile terminal 20. Given this, at the timing when it is necessary to present the ticket, the ticket is displayed on the touch panel display of the mobile terminal 20, to be presented. The event staff who cancels the entry ticket applies the stamp for the event to the touch panel display whereon the ticket is displayed, to define the entry ticket as having been used. When the cancellation process is performed, the server 40 and the mobile terminal 20 exchange, for example, information on the ticket being canceled, the time and date at which the ticket is canceled, the location at which the cancellation occurs, and so forth. Moreover, whether or not the stamp that is applied corresponds to the ticket that is displayed, and whether or not the time of cancellation is within the period of validity of the entry ticket, and the like, are evaluated, and the cancellation is carried out if all conditions are satisfied. The evaluation of the conditions may be performed by the mobile terminal 20, or may be performed by the server 40. Moreover, a portion of the evaluation may be performed by the mobile terminal 20, with the balance performed by the server 40. If the conditions are not satisfied, an error notification may be carried out through the display, a tone, a vibration, or the like. This makes it possible to prevent illegal entry.

While the present invention was explained above using embodiments, the scope of technology of the present invention is not limited to the range described in the embodiments. To one skilled in the art, it is obvious that a variety of alterations or improvements can be made to the embodiments described above. Forms wherein there are these alterations or improvements also being included within the scope of technology of the present invention is obvious from the descriptions in the claims.

For example, while in the embodiments set forth above the correspondence between layout information and the coupon information, checkpoint, or ticket information corresponding thereto is stored in the server 40, and whether or not there is a correspondence relationship between the coupon information, checkpoint, or ticket information and the layout information received from the mobile terminal 20 is evaluated within the server 40, the layout information and the coupon information or checkpoint information corresponding thereto instead may be stored in advance in the mobile terminal 20, and the mobile terminal 20 itself may confirm whether or not there is the correspondence relationship.

Moreover, while in the various embodiments described above the explanations are for examples of cases wherein a cancellation process is performed through applying a stamp, to define the coupon or ticket as having been used, a method other than the application of a stamp may be selected as the operation for carrying out the cancellation process. For example, a method may be selected such as inputting a predetermined security number, reading in a barcode or a two-dimensional code (for example, a QR code (registered trademark), inputting a tone of a predetermined pattern or wavelength through the microphone, or carrying out a predetermined operation on the touch panel display of the mobile terminal 20, to execute the cancellation process. For example, a cancellation method that is used in association with the coupon or ticket identifying information may be stored in the coupon information storing portion 45 or the ticket information storing portion 47.

### REFERENCE SIGNS LIST

10 Coupon Issuing System
20 Mobile Terminal
30 Stamp
40 Server

1. An electronic ticket system comprising: a user terminal for displaying an electronic ticket on displaying means, having a touch panel having: the displaying means for displaying information; and inputting means provided overlaying the displaying means, the inputting means being capable of detecting respective contact positions of simultaneous contacting of a plurality of positions; and
a stamp having a plurality of pressing portions for which simultaneous contacts to the inputting means are detectable,
a server device able to communicate with the user terminal, wherein
the user terminal stores in advance information pertaining to a layout of the plurality of pressing portions of at least one stamp, in relation to the electronic ticket corresponding to the stamp, and before providing a service corresponding to the use of the electronic ticket, when, in the user terminal, there are simultaneous contacts by pressing portions of the stamp, in a state wherein the electronic ticket is displayed on the displaying means, a plurality of contact positions are detected by the inputting means, and if the detected contact positions correspond to the information pertaining to the layout of the pressing portions corresponding to the electronic ticket displayed on the displaying means, the terminal draws an image indicating that the electronic ticket has been used, and provides notification that the electronic ticket has been used to the server device, and
wherein the electronic ticket is permitted to be associated with information identifying a plurality of stamps.

2. (canceled)

3. An electronic ticket system as set forth in claim 1, further comprising a server device able to communicate with the user terminal, wherein
the server device stores information pertaining to the layout of the plurality of pressing portions of the stamp, in relation to the electronic ticket corresponding to the stamp, and when, in a state wherein the electronic ticket is displayed on the displaying means, when all of the pressing portions of the stamp are detected, by the inputting means, as having made contact simultaneously, the user terminal queries the server device as to whether or not the detected contact positions correspond to the displayed electronic ticket, and when there is a response to the effect that they correspond, draws, on the displaying means, an image indicating that the electronic ticket has been used.

4. An electronic ticket system as set forth in claim 3, wherein, at the time of a response, to the query from the user terminal, indicating that there is a correspondence, the server device records that the electronic ticket has been used by the user of the user terminal.

5. An electronic ticket system as set forth in claim 1, wherein the server device further comprises an information providing portion for providing an electronic ticket addressed to the user.

6. An electronic ticket system as set forth in claim 5, wherein in a state wherein the displaying means displays an indication of a request for an electronic ticket, when there is contact simultaneously by all of the pressing portions of the stamp, the plurality of contact positions are detected by the inputting means and the user terminal requests the server device to provide the electronic ticket corresponding to the detected contact positions, and
in response to the request from the user terminal, the server device provides, to the user terminal that is the source of the request, an electronic ticket corresponding to the contact positions.

7. (canceled)

8. An electronic ticket system as set forth in claim 3, wherein the server device further comprises an information providing portion for providing an electronic ticket addressed to the user.

9. An electronic ticket system as set forth in claim 4, wherein the server device further comprises an information providing portion for providing an electronic ticket addressed to the user.
